(19) United States
(12) Patent Application Publication
(10) Pub. No.: US 2025/0351219 A1
(43) Pub. Date: Nov. 13, 2025

(54) TECHNIQUES TO SUPPORT NETWORK-CONTROLLED REPEATER FUNCTIONALITY FOR DISCONTINUOUS COMMUNICATIONS

(71) Applicant: QUALCOMM Incorporated, San Diego, CA (US)

(72) Inventors: Ahmed Attia ABOTABL, San Diego, CA (US); Navid ABEDINI, Basking Ridge, NJ (US); Diana MAAMARI, San Diego, CA (US)

(21) Appl. No.: 18/657,494

(22) Filed: May 7, 2024

(51) Int. Cl. H04W 76/28; H04W 84/04

(52) U.S. Cl. CPC H04W 76/28; H04W 84/047

(57) ABSTRACT

Methods, systems, and devices for wireless communications are described. A network-controlled repeater (NCR) may obtain one or more messages that are indicative of a set of periodic resources to forward to one or more user equipment (UEs). The one or more messages may also indicate one or more inactive durations of a cell discontinuous transmission (DTX) cycle associated with a network entity, one or more inactive durations of a cell discontinuous reception (DRX) cycle associated with the network entity, or both. The NCR may then obtain the set of periodic resources from the network entity, and may output or forward at least a portion of the set of periodic resources to the one or more UEs. The NCR may forward the portion of the set of periodic resources that overlaps with one or more active durations of the cell DTX cycle, the cell DRX cycle, or both.

### FIELD OF TECHNOLOGY

The following relates to wireless communications, including techniques to support network-controlled repeater (NCR) functionality for discontinuous communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by an apparatus is described. The method may include obtaining one or more messages indicative of a set of periodic resources to forward to one or more user equipment (UEs) and indicative of one or more inactive durations of a cell discontinuous transmission (DTX) cycle associated with a network entity, one or more inactive durations of a cell discontinuous reception (DRX) cycle associated with the network entity, or both, obtaining, from the network entity, the set of periodic resources to forward to the one or more UEs, and outputting, from a network-controlled repeater (NCR), at least a portion of the set of periodic resources to the one or more UEs in accordance with the one or more messages, where the portion of the set of periodic resources overlaps with one or more active durations of the cell DTX cycle, one or more active durations of the cell DRX cycle, or both.

An apparatus for wireless communications is described. The apparatus may include one or more memories storing processor executable code, and one or more processors coupled with the one or more memories. The one or more processors may individually or collectively be operable to execute the code to cause the apparatus to obtain one or more messages indicative of a set of periodic resources to forward to one or more UEs and indicative of one or more inactive durations of a cell DTX cycle associated with a network entity, one or more inactive durations of a cell DRX cycle associated with the network entity, or both, obtain, from the network entity, the set of periodic resources to forward to the one or more UEs, and output, from an NCR, at least a portion of the set of periodic resources to the one or more UEs in accordance with the one or more messages, where the portion of the set of periodic resources overlaps with one or more active durations of the cell DTX cycle, one or more active durations of the cell DRX cycle, or both.

Another apparatus for wireless communications is described. The apparatus may include means for obtaining one or more messages indicative of a set of periodic resources to forward to one or more UEs and indicative of one or more inactive durations of a cell DTX cycle associated with a network entity, one or more inactive durations of a cell DRX cycle associated with the network entity, or both, means for obtaining, from the network entity, the set of periodic resources to forward to the one or more UEs, and means for outputting, from an NCR, at least a portion of the set of periodic resources to the one or more UEs in accordance with the one or more messages, where the portion of the set of periodic resources overlaps with one or more active durations of the cell DTX cycle, one or more active durations of the cell DRX cycle, or both.

A non-transitory computer-readable medium storing code for wireless communications is described. The code may include instructions executable by one or more processors to obtain one or more messages indicative of a set of periodic resources to forward to one or more UEs and indicative of one or more inactive durations of a cell DTX cycle associated with a network entity, one or more inactive durations of a cell DRX cycle associated with the network entity, or both, obtain, from the network entity, the set of periodic resources to forward to the one or more UEs, and output, from an NCR, at least a portion of the set of periodic resources to the one or more UEs in accordance with the one or more messages, where the portion of the set of periodic resources overlaps with one or more active durations of the cell DTX cycle, one or more active durations of the cell DRX cycle, or both.

In some examples of the method, apparatus, and non-transitory computer-readable medium described herein, the one or more messages indicate the one or more inactive durations of the cell DTX cycle or the one or more inactive durations of the cell DRX cycle associated with both a serving cell and one or more non-serving cells of the NCR.

In some examples of the method, apparatus, and non-transitory computer-readable medium described herein, the one or more messages indicate an effective configuration for a combination of the one or more inactive durations of the cell DTX cycle or the one or more inactive durations of the cell DRX cycle associated with both a serving cell and one or more non-serving cells of the NCR.

In some examples of the method, apparatus, and non-transitory computer-readable medium described herein, the effective configuration indicates overlapping active durations of the one or more inactive durations of the cell DTX cycle or the one or more inactive durations of the cell DRX cycle associated with both the serving cell and the one or more non-serving cells of the NCR.

In some examples of the method, apparatus, and non-transitory computer-readable medium described herein, the one or more messages indicate a frequency allocation for a serving cell associated with the NCR and respective frequency allocations for one or more non-serving cells of the NCR.

In some examples of the method, apparatus, and non-transitory computer-readable medium described herein, outputting at least the portion of the set of periodic resources to the one or more UEs may include operations, features, means, or instructions for outputting a first portion of the set of periodic resources that may be overlapping with the one or more active durations of the cell DTX cycle, the one or more active durations of the cell DRX cycle, or both, where at least the portion of the set of periodic resources omits one or more second portions of the set of periodic resources that may be non-overlapping with the one or more active durations of the cell DTX cycle, the one or more active durations of the cell DRX cycle, or both.

In some examples of the method, apparatus, and non-transitory computer-readable medium described herein, the set of periodic resources include periodic resources or semi-persistent resources, and outputting at least the portion of the set of periodic resources to the one or more UEs may include operations, features, means, or instructions for outputting at least the portion of the set of periodic resources that may be overlapping with the one or more active durations of the cell DTX cycle, the one or more active durations of the cell DRX cycle, or both, obtaining a set of dynamically granted resources during one or more active or inactive durations of the cell DTX cycle, one or more active or inactive durations of the cell DRX cycle, or both, and outputting the set of dynamically granted resources during the one or more active or inactive durations of the cell DTX cycle, the one or more active or inactive durations of the cell DRX cycle, or both.

In some examples of the method, apparatus, and non-transitory computer- readable medium described herein, outputting at least the portion of the set of periodic resources to the one or more UEs comprises outputting a first portion of the set of periodic resources, and the method, apparatuses, and non-transitory computer-readable medium may include further operations, features, means, or instructions for outputting the first portion of the set of periodic resources that may be overlapping with the one or more active durations of the cell DTX cycle, the one or more active durations of the cell DRX cycle, or both, obtaining a flag that indicates an expected forwarding behavior of the NCR, and outputting, based on the flag, one or more second portions of the set of periodic resources that may be non-overlapping with the one or more active durations of the cell DTX cycle, the one or more active durations of the cell DRX cycle, or both.

In some examples of the method, apparatus, and non-transitory computer-readable medium described herein, obtaining the flag may include operations, features, means, or instructions for receiving the flag via one or more dynamic messages from the network entity.

In some examples of the method, apparatus, and non-transitory computer-readable medium described herein, obtaining the flag may include operations, features, means, or instructions for receiving the flag via the one or more messages indicative of the set of periodic resources to forward to one or more UEs, where the flag includes a configured indicator.

In some examples of the method, apparatus, and non-transitory computer-readable medium described herein, the flag instructs the NCR to output the one or more second portions of the set of periodic resources irrespective of whether the one or more second portions of the set of periodic resources may be non-overlapping with the one or more active durations of the cell DTX cycle, the one or more active durations of the cell DRX cycle, or both.

In some examples of the method, apparatus, and non-transitory computer-readable medium described herein, the network entity includes a next generation node B (gNB), an integrated access and backhaul (IAB) node or other network node, or any combination thereof.

A method for wireless communications by a network entity is described. The method may include outputting one or more messages indicative of a set of periodic resources to forward from an NCR to one or more UEs and indicative of one or more inactive durations of a cell DTX cycle associated with the network entity, one or more inactive durations of a cell DRX cycle associated with the network entity, or both and outputting, to the NCR, the set of periodic resources to forward to the one or more UEs based on the one or more messages.

A network entity for wireless communications is described. The network entity may include one or more memories storing processor executable code, and one or more processors coupled with the one or more memories. The one or more processors may individually or collectively be operable to execute the code to cause the network entity to output one or more messages indicative of a set of periodic resources to forward from an NCR to one or more UEs and indicative of one or more inactive durations of a cell DTX cycle associated with the network entity, one or more inactive durations of a cell DRX cycle associated with the network entity, or both and output, to the NCR, the set of periodic resources to forward to the one or more UEs based on the one or more messages.

Another network entity for wireless communications is described. The network entity may include means for outputting one or more messages indicative of a set of periodic resources to forward from an NCR to one or more UEs and indicative of one or more inactive durations of a cell DTX cycle associated with the network entity, one or more inactive durations of a cell DRX cycle associated with the network entity, or both and means for outputting, to the NCR, the set of periodic resources to forward to the one or more UEs based on the one or more messages.

A non-transitory computer-readable medium storing code for wireless communications is described. The code may include instructions executable by one or more processors to output one or more messages indicative of a set of periodic resources to forward from an NCR to one or more UEs and indicative of one or more inactive durations of a cell DTX cycle associated with the network entity, one or more inactive durations of a cell DRX cycle associated with the network entity, or both and output, to the NCR, the set of periodic resources to forward to the one or more UEs based on the one or more messages.

In some examples of the method, network entities, and non-transitory computer-readable medium described herein, the one or more messages indicate the one or more inactive durations of the cell DTX cycle or the one or more inactive durations of the cell DRX cycle associated with both a serving cell and one or more non-serving cells of the NCR.

In some examples of the method, network entities, and non-transitory computer-readable medium described herein, the one or more messages indicate an effective configuration for a combination of the one or more inactive durations of the cell DTX cycle or the one or more inactive durations of the cell DRX cycle associated with both a serving cell and one or more non-serving cells of the NCR.

In some examples of the method, network entities, and non-transitory computer-readable medium described herein, the effective configuration indicates overlapping active durations of the one or more inactive durations of the cell DTX cycle or the one or more inactive durations of the cell DRX cycle associated with both the serving cell and the one or more non-serving cells of the NCR.

In some examples of the method, network entities, and non-transitory computer-readable medium described herein, the one or more messages indicate a frequency allocation for a serving cell associated with the NCR, and respective frequency allocations for one or more non-serving cells of the NCR.

Some examples of the method, network entities, and non-transitory computer-readable medium described herein may further include operations, features, means, or instructions for outputting a set of dynamically granted resources for the NCR to forward during one or more active or inactive durations of the cell DTX cycle, one or more active or inactive durations of the cell DRX cycle, or both.

Some examples of the method, network entities, and non-transitory computer-readable medium described herein may further include operations, features, means, or instructions for outputting a flag that indicates an expected forwarding behavior of the NCR, where the flag instructs the NCR to output the set of periodic resources irrespective of whether the set of periodic resources may be non-overlapping with one or more active durations of the cell DTX cycle, one or more active durations of the cell DRX cycle, or both.

In some examples of the method, network entities, and non-transitory computer-readable medium described herein, the network entity includes a gNB, an IAB node or other network node, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for network-controlled repeater (NCR) functionality for discontinuous communications in accordance with one or more aspects of the present disclosure.

FIG. 2 shows an example of a wireless communications system that supports techniques for NCR functionality for discontinuous communications in accordance with one or more aspects of the present disclosure.

FIG. 3 shows an example of NCR forwarding configurations that support techniques for NCR functionality for discontinuous communications in accordance with one or more aspects of the present disclosure.

FIG. 4 shows an example of a process flow that supports techniques for NCR functionality for discontinuous communications in accordance with one or more aspects of the present disclosure.

FIGS. 5 and 6 show block diagrams of devices that support techniques for NCR functionality for discontinuous communications in accordance with one or more aspects of the present disclosure.

FIG. 7 shows a block diagram of a communications manager that supports techniques for NCR functionality for discontinuous communications in accordance with one or more aspects of the present disclosure.

FIG. 8 shows a diagram of a system including a device that supports techniques for NCR functionality for discontinuous communications in accordance with one or more aspects of the present disclosure.

FIGS. 9 and 10 show flowcharts illustrating methods that support techniques for NCR functionality for discontinuous communications in accordance with one or more aspects of the present disclosure.

### DETAILED DESCRIPTION

Some wireless communications systems my implement different radio frequency (RF) repeater devices such as network-controlled repeaters (NCRs) to extend network coverage on various frequency bands. An NCR may forward signals from a network entity (such as a next generation nodeB (gNB) or an integrated access and backhaul (IAB) node) to UEs that are located at the edge of a coverage area or cell served by the network entity. NCRs may also support beamforming capabilities and capabilities to receive and process control information from the network entity. For example, an NCR may receive an indication of dynamic, periodic, or semi-persistent signals to forward from the network entity to the one or more cell-edge UEs.

In addition, a wireless communication system that supports NCRs may also operate using a discontinuous reception (DRX) and/or discontinuous transmission (DTX) configurations, which indicate a set of active durations (where the network entity or other devices are expected to be transmitting or receiving information) and inactive durations (where the network entity or other devices are expected to be relatively inactive or asleep). In some cases, however, the network may still transmit signaling (such as synchronization signals or other signals) during the inactive durations, which the NCR may receive and erroneously forward to the one or more UEs. Additionally, or alternatively, the network entity may have a quantity of resources that are unavailable for use, and NCR, at least in some cases, may erroneously forward resources that are indicated as unavailable. In such cases, the improper resource forwarding of resources by the NCR may unnecessarily increase network energy expenditure, among other challenges.

To increase the efficiency of communications for the NCR, the network entity may communicate the DTX/DRX configuration associated with network entity (and any unavailable resources) to the NCR, so that the NCR may identify which resources to forward, and which resources to exclude from forwarding (e.g., based on the DTX/DRX cycle of the network entity). For example, the network entity may provide the NCR with a configuration of a cell DTX/DRX configuration (and/or a set of resources that are indicated as unavailable for the network entity) and a set of resources for the NCR to forward to one or more UEs. The NCR may forward the resources to the one or more UEs based on the one or more resources overlapping with active times of the DTX/DRX configuration of the network entity, so that the NCR excludes forwarding information during times where the network is inactive. Additionally, or alternatively, the network entity may dynamically grant resources for forwarding by the NCR such that the NCR may forward resources outside of the active durations if the resources are dynamically granted or otherwise flagged for forwarding by the network.

Aspects of the disclosure may be implemented to realize one or more potential advantages. For example, knowledge of the cell DTX/DRX configuration at the NCR may allow for the NCR to effectively coordinate its forwarding with the inactive and active durations of the network, which may increase network power savings. For example, the NCR may remain inactive (e.g., in a low power or inactive state) during inactive times of the cell DTX/DRX configuration, and may not wake up to forward messages until an active duration of the network. In addition, the techniques described herein may allow for UE power savings, as the UEs may not receive erroneously forwarded resources from the NCR during inactive durations of the DTX/DRX configuration. The techniques described herein may also provide increased flexibility for controlling the NCR, as the NCR can be configured to either forward resources during active times only, or for dynamically granted resources. Additionally, or alternatively, the techniques described herein may support extended coverage and increased reliability for UEs, as the NCR may forward or amplify signals from the network entity to UEs that are at the edge of a coverage area for the network entity.

Aspects of the disclosure are initially described in the context of wireless communications systems. Aspects of the disclosure are further illustrated by and described with reference to NCR forwarding configurations, a process flow, apparatus diagrams, system diagrams, and flowcharts that relate to techniques to support NCR functionality for discontinuous communications.

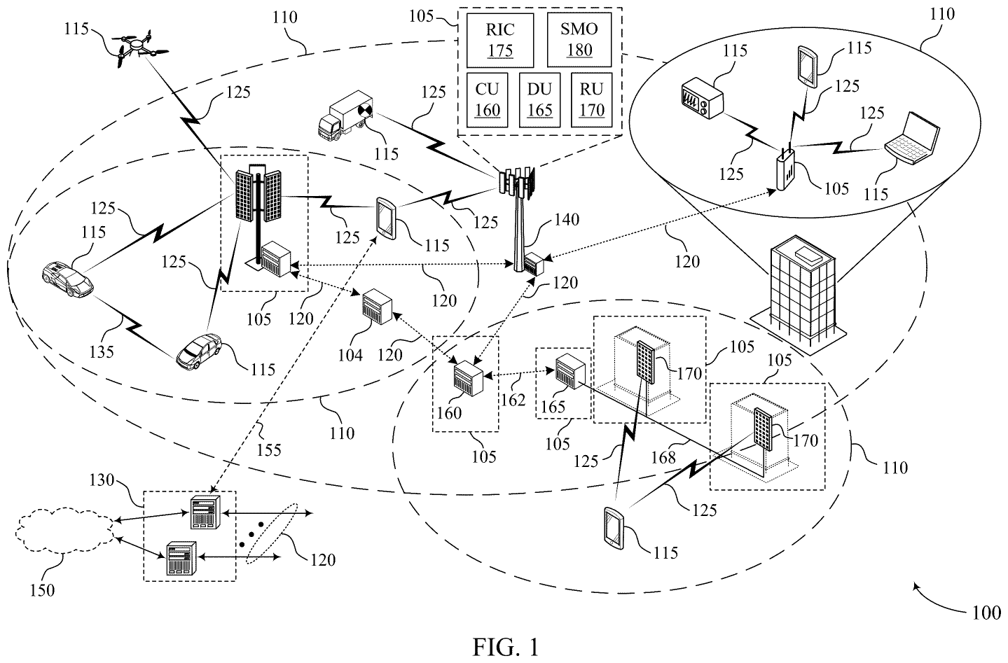

FIG. 1 shows an example of a wireless communications system 100 that supports techniques to support NCR functionality for discontinuous communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum, and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications networks, a UE 115 and a network entity 105 may consume a certain amount of energy to communicate within a radio access network (RAN). For example, in a network entity energy consumption model, the total energy consumption may be based on a relative energy consumption for downlink and uplink transmissions, sleep states associated with the network entity 105, associated transition times of the sleep states, and one or more reference parameters or configurations. The total energy consumption may be further based on factors such as power added (PA) efficiency, number of transmission radio units (TxRUs), and the network entity load of a network entity 105. In this example, communications within a cellular network (e.g., a high traffic scenario) may be associated with a high cost of network energy consumption (e.g., 23% of total cost).

The network energy consumption may be evaluated based on assessing network entity and UE communications (e.g., spectral efficiency, capacity, user perceived throughput (UPT), latency, handover performance, call drop rate, initial access performance, service level agreement (SLA) assurance related key performance indicator (KPIs), etc.), energy efficiency, and UE power consumption. For example, multiple KPIs may be evaluated for a network. In this case, performing communications within RAN uses a majority of the network energy consumption (e.g., running a 5G network uses up around 50% of the network energy). The high cost of network energy consumption associated with the RAN may result in increased latency in communications and may result in an inability to expand cellular networks, thus a network may be implemented to achieve more efficient operation and reduced energy expenditure. For example, a network may dynamically and/or semi-statically support transmissions and/or receptions that align with various network energy saving techniques. For example, the one or more energy saving techniques may be implemented for signaling in time, frequency, spatial, and power domains, with support for feedback transmissions from a UE 115, potential UE assistance information exchange, and other information exchange and coordination over network interfaces.

One implementation of energy saving for wireless communications system 100 and associated wireless devices (e.g., UEs 115) includes for DTX/DRX mechanisms. For example, a network entity 105 and a UE 115 may operate in accordance with one or more DTX/DRX configurations, which allows the network entity 105 and the UE 115 to save power by transitioning to an inactive or idle state during inactive periods of a DTX/DRX cycle associated with the DTX/DRX configuration. In some aspects, a network entity 105 may operate in accordance with a cell-specific DTX/DRX configuration, and a UE 115 may operate in accordance with a UE-specific DTX/DRX configuration. In some examples, the cell-specific DTX/DRX configuration and the UE-specific DTX/DRX configuration may be aligned when the UE 115 is operating in an RRC-connected made. Additionally, or alternatively, cell DTX/DRX may support inter-node information exchange, including communication between different cells using different DTX/DRX configurations.

The wireless communications system 100 may support communications with one or more NCRs to extend the coverage area of the network and to provide improved service for UEs that are located at the edge of the service area (or in areas that experience reduced coverage). An NCR may have different components, including an NCR-Mobile Termination (NCR-MT) radio and an NCR-Forwarding (NCR-Fwd) radio. The NCR-MT block may establish communication with at least one network entity 105 using a control link via the Uu interface. This established connection enables the exchange of side control information, such as beamforming information, uplink and downlink switching information, among other information, to allow the NCR to manage the NCR-Fwd block. The NCR-MT provides the exchange of control and status signaling with the network entity 105 via a control link.

The NCR-Fwd radio may amplify and forward uplink or downlink radio frequency signals between one or more network entities 105 and the one or more UEs through backhaul and access links. In some implementations, the NCR-Fwd radio may be implemented with two sets of panel antennas (e.g., one for the backhaul link and the other for the access link), along with a radio frequency amplifier. The NCR-Fwd radio may support signal amplification and (analog) beamforming. In addition, the performance requirements for beamforming antennas in the NCR-Fwd may be relaxed relative to those for other network entities 105 or IAB node antennas. The NCR may also be relatively cost effective, and may have reduced complexity relative to other network devices.

Both the NCR-MT and NCR-Fwd may operate in the same or different frequency bands. In some aspects, at least one carrier used by the NCR-MT may operate within the frequency band being forwarded by the NCR-Fwd (e.g., serving as a baseline carrier). When the NCR-MT and NCR-Fwd operate in the same frequency band, the control link and backhaul link may experience similar large-scale channel properties, which may reduce the complexity for controlling the backhaul link between a network entity 105 and the NCR-Fwd.

In some aspects, devices such as network entities 105 located in the wireless communications system 100 may operate using a DTX/DRX configuration, where the network entity 105 may transmit or receive communications during active durations of the DTX/DRX configuration, and may remain relatively inactive during inactive durations. In some implementations, however, a network entity 105 may still transmit some signaling (such as synchronization signals or other signals) during the inactive durations, which an NCR may receive and erroneously forward to the one or more UEs 115. Additionally, or alternatively, the network entity 105 may have a quantity of resources that are unavailable for use, and NCR, at least in some cases, may erroneously forward resources that are indicated as unavailable. In such cases, the improper resource forwarding of resources by the NCR may unnecessarily increase network energy expenditure, among other challenges.

To increase the efficiency of communications for the NCR, the network entity 105 may communicate the DTX/DRX configuration associated with network entity 105 (and any unavailable resources) to the NCR, so that the NCR may identify which resources to forward, and which resources to exclude from forwarding (e.g., based on the DTX/DRX cycle of the network entity 105). For example, the network entity 105 may provide the NCR with a configuration of a cell DTX/DRX configuration (and/or a set of resources that are indicated as unavailable for the network entity 105) and a set of resources for the NCR to forward to one or more UEs 115. The NCR may forward the resources to the one or more UEs 115 based on the one or more resources overlapping with active times of the DTX/DRX configuration of the network entity 105, so that the NCR excludes forwarding information during times where the network is inactive.

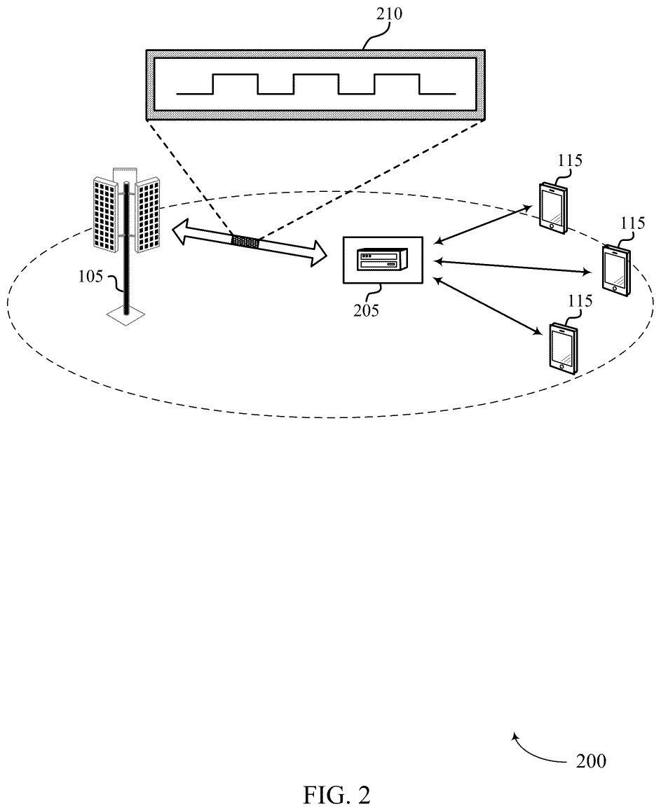

FIG. 2 shows an example of a wireless communications system 200 that supports techniques to support NCR functionality for discontinuous communications in accordance with one or more aspects of the present disclosure. For example, the wireless communications system 200 may illustrate communications between a network entity 105 (which may be an example of an IAB node, a gNB, or any other network entity 105 described herein), an NCR 205, and one or more UEs 115, which may be examples of UEs 115 described herein.

The wireless communications system 200 may utilize one or more NCRs (e.g., NCR 205) to extend network coverage on different frequency bands, such as FR1(sub 6 GHz) and FR2 (mmW) bands. For example, the NCR 205 may function as a signal repeater, and may forward signals associated with different resources from the network entity 105 (such as a gNB or IAB node) to UEs 115. In some aspects, the NCR 205 may extend the coverage of the network entity 105 to cell-edge UEs (e.g., UEs 115) that are located at the edge of a cell coverage area of the network entity 105. The NCR 205 may also, unlike repeaters that are non-network controlled, support beamforming capabilities and capabilities to receive and process control information from the network entity 105. For example, the NCR 205 may be considered as “always off” until receiving an indication (e.g., via dynamic, periodic, or semi-persistent signaling) of signals that the NCR may forward to one or more of the UEs 115. In some such examples, the NCR 205 may be unaware of the type of signals or channels it forwards to the UEs 115.

In addition, the network entity 105 may operate in accordance with a DRX and/or DTX configuration, which indicates a set of active durations (where the network is expected to be transmitting or receiving information) an inactive durations (where the network is expected to be inactive). In some cases, however, an NCR may receive resources to forward during one or more inactive durations of the network DTX/DRX cycle, or resources that are indicated as unavailable. For example, in some aspects, the network entity 105 may be an example of an IAB node connected to a macro node or another network entity via a backhaul link. The IAB node may be allocated different resources, including hard resources (e.g., resources allocated for only the IAB node in one or more slots), soft resources (e.g., resources allocated for the IAB node and at least one other IAB node), and unavailable resources (e.g., resources that are indicated as unavailable for use by the IAB node with the exception of SSB, RACH, Type0-PDCCH, CSS, SR, and CSI-RS signaling, in which the IAB node may transmit via the unavailable resources).

In some cases, the NCR 205 may be unaware of the DTX/DRX cycle of the network entity 105, and may be unaware of the unavailable resources. In such cases, the NCR 205 may erroneously forward resources that fall within inactive periods of the cell DTX/DRX cycle (or that are received via the unavailable resources) to the UE, which may increase network energy expenditure and reduce the efficiency of communications using the NCR 205. For example, even though the NCR may have an established connection via an NCR mobile terminal (MT), the NCR MT may be associated with a single serving cell (e.g., the NCR 205 may receive communications via a single serving cell), while the NCR 205 is expected to forward a wideband channel (via an NCR forward (FWD) radio) that spans multiple component carriers. In such examples, the NCR 205 may receive the DTX/DRX configuration of the single serving cell that provides information, but may lack information regarding the wideband channel to which the NCR 205 forwards information. Additionally, or alternatively, in some aspects, the NCR 205 may be unaware of the unavailable resources of the network entity 105 (or any associated IAB nodes).

To increase the coordination and energy efficiency for the NCR 205, and to reduce the likelihood that the NCR 205 forwards resources that fall within inactive durations of the DTX/DRX cycle (or that are otherwise indicated as unavailable resources), the network entity 105 may support different techniques to communicate the DTX/DRX configuration 210 of the network entity 105 (and indications of the unavailable resources) to the NCR 205. Based on knowledge of the DTX/DRX configuration 210, the NCR may effectively determine which resources or communications to forward to the UEs, and which resources to refrain from forwarding (e.g., based on the DTX/DRX cycle of the network entity 105).

For example, the network entity 105 may provide the NCR 205 with a configuration of a cell DTX/DRX configuration 210 (and/or a set of resources that are indicated as unavailable for the network entity) and a set of resources to forward to the one or more UEs 115. The NCR 205 may forward the resources to the one or more UEs 115 based on the one or more resources overlapping with active times of the DTX/DRX configuration 210 of the network entity 105, so that the NCR 205 does not forward information received during times where the network entity 105 is inactive (at least according to the DTX/DRX configuration 210). For example, the network entity 105 (or an IAB node) may still transmit select signaling (such as SSBs) during times of inactivity (according to the DTX/DRX cycle), and the NCR 205 may receive these select signals during the inactive times. Using the DTX/DRX configuration 210, the NCR may determine that the signals received during the inactive times are not meant for forwarding, and the NCR may refrain from forwarding the signals. The knowledge of the DTX/DRX configuration 210 of the network entity 105 and of any unavailable resources may allow the NCR 205 (and the UEs 115) to save power by forwarding only the applicable signals received while the network entity 105 is active, and not forwarding signals that are not indicated for the UEs 115.

In addition, to further increase the flexibility of the communications between the NCR 205 and the network entity 105, the network entity 105 may dynamically grant resources for forwarding by the NCR 205, including resources that may fall outside of the active durations of the DTX/DRX configuration 210. For example, if the resources are dynamically granted or otherwise flagged for forwarding by the network, the NCR 205 may forward the resources to the UEs. The knowledge of the cell DTX/DRX configuration 210 at the NCR 205 may allow for the NCR 205 to effectively coordinate resource forwarding with the inactive and active durations of the network, which may increase network power savings.

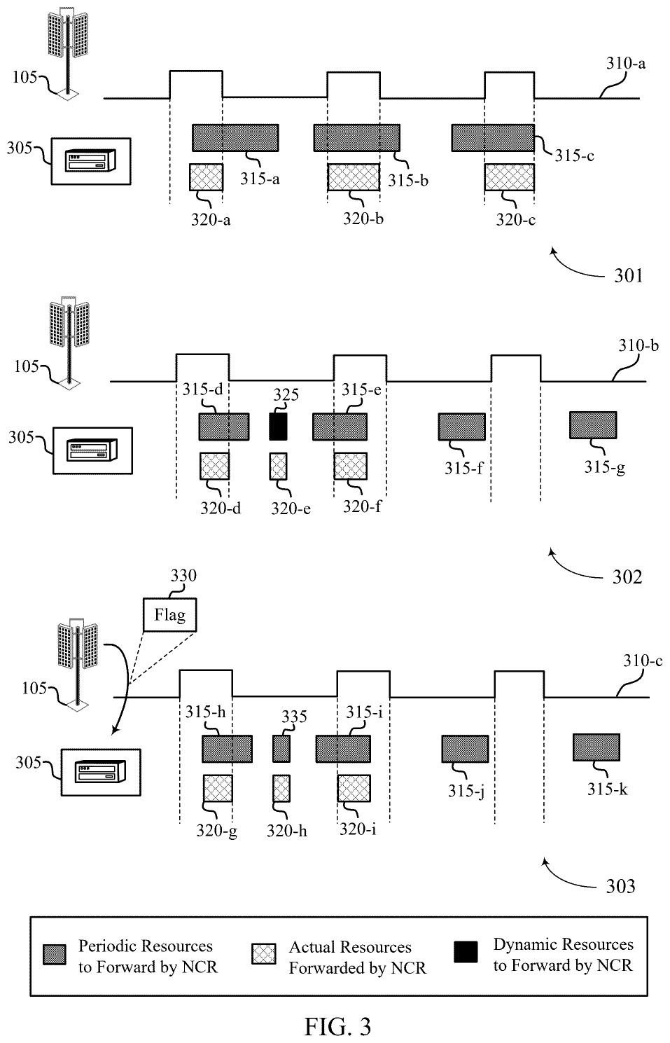

FIG. 3 shows an example of an NCR forwarding configuration 301, an NCR forwarding configuration 302, and an NCR forwarding configuration 303 that supports techniques to support NCR functionality for discontinuous communications in accordance with one or more aspects of the present disclosure. For example, the NCR forwarding configuration 301, the NCR forwarding configuration 302, and the NCR forwarding configuration 303 may support communications between a network entity 105 and an NCR 305, which may be examples of network entities, IAB nodes, and NCRs described herein. In each NCR forwarding configuration, the network entity 105 may communicate, with the NCR 305, an indication of a DTX/DRX configuration (e.g., DTX/DRX configuration 310-a, DTX/DRX configuration 310-b, DTX/DRX configuration 310-c), an indication of unavailable resources for the network entity 105, or both, which the NCR 305 may use to determine which signals to forward to one or more UEs.

In some implementations, the NCR 305 may have different RF components, including an NCR-MT radio and an NCR-Fwd radio. The NCR-MT radio may establish communication with the network entity 105 using a control link via the Uu interface on a single serving cell. The NCR-Fwd radio may then amplify and forward uplink or downlink signals to or from one or more UEs through backhaul and access links. In some implementations, the NCR-Fwd radio may forward signals as wideband signals on multiple component carriers that are different from the serving cell of the NCR-MT. In some aspects, when the NCR 305 functions as an out of band repeater, the serving cell of the NCR-MT of the NCR 305 may be at least partially or completely outside the bandwidth of the NCR-Fwd of the NCR 305. In such implementations, the network entity 105 may communicate the DTX/DRX configuration for the non-serving cells (e.g., associated with the different component carriers of the NCR-Fwd) to the NCR 305. The NCR 305 may have DTX/DRX information from the NCR-MT of the serving cell, so receiving the DTX/DRX configuration for the non-serving cells may allow the NCR 305 to have complete knowledge of the DTX/DRX configuration of the network.

In some other implementations, the network entity 105 may communicate an “effective” cell DTX/DRX configuration with the NCR 305, the effective cell DTX/DRX including a union of cell DTX/DRX configurations across the bandwidth of the NCR-Fwd. For example, the effective cell DTX/DRX configuration may be configured by the network entity 105 such that the effective cell DTX/DRX configuration includes an indication of a combination of the active durations for the non-serving cell DTX/DRX configurations across the bandwidth of the NCR-Fwd. In some examples, the effective cell DTX/DRX configuration may optimize the forwarding behavior of the NCR 305 by including each possible active duration that the NCR 305 may monitor for forwarding communications. In some other examples, the effective cell DTX/DRX configuration may include an indication of a combination of the active durations for the non-serving cell DTX/DRX configurations and for the serving cell DTX/DRX configurations. Additionally, or alternatively, the network entity 105 may transmit an indication of a frequency allocation of each cell (e.g., for the serving cell and for one or more non-serving cells) to the NCR 305, so that the NCR is aware of the different frequencies of the NCR-Fwd.

In some other implementations, for example, when the network entity 105 is an IAB node, the network entity 105 may transmit an indication of one or more unavailable resources to the NCR 305 so that the NCR 305 may be aware of resources that are unavailable to the network entity 105. The NCR 305 may then refrain from forwarding resources that the NCR 305 may receive during the indicated unavailable resources (e.g., SSBs or other signaling).

The NCR forwarding configuration 301 illustrates communications between a network entity 105 and an NCR 305. The network entity 105 may transmit, to the NCR 305, an indication of a DTX/DRX configuration 310-a, which includes a set of active and inactive durations for the network entity 105. The network entity 105 may also transmit an indication of a set of resources (e.g., resource 315-a, resource 315-b, resource 315-c) that are configured for forwarding by the NCR 305.

In some aspects, the NCR-Fwd of the NCR 305 may forward signals and channels configured for remote UEs that are served by the NCR 305. In addition, the NCR-Fwd may have one or more filtering capabilities (e.g., capabilities to forward signals associated with at least a portion of the bandwidth, while filtering out some other portions of the bandwidth or other component carriers). In such cases, some component carriers may be associated with an activated cell DTX/DRX, while some component carriers are associated with a deactivated cell DTX/DRX. The NCR 305 may forward component carriers that are associated with an activated cell DTX/DRX.

In some aspects, the NCR 305 may use the indication of the DTX/DRX configuration 310-a to determine which portions of the set of resources (e.g., resource 315-a, resource 315-b, resource 315-c) to forward to one or more UEs. In such aspects, the NCR 305 may forward portions of the resources that are overlapping with the DTX/DRX configuration 310-a. For example, the NCR 305 may forward the resource 320-a, which is the portion of the resource 315-a that overlaps with the first active duration of the DTX/DRX configuration 310-a. The NCR 305 may also forward the resource 320-b, which is the portion of the resource 315-b that overlaps with the second active duration of the DTX/DRX configuration 310-a. The NCR 305 may also forward the resource 320-c, which is the portion of the resource 315-c that overlaps with the third active duration of the DTX/DRX configuration 310-a.

The NCR forwarding configuration 302 illustrates communications between a network entity 105 and an NCR 305. The network entity 105 may transmit, to the NCR 305, an indication of a DTX/DRX configuration 310-b, which includes a set of active and inactive durations for the network entity 105. The network entity 105 may also transmit an indication of a set of resources (e.g., resource 315-d, resource 315-e, resource 315-f) that are configured for forwarding by the NCR 305.

In some aspects, the NCR 305 may use the indication of the DTX/DRX configuration 310-b to determine which portions of the set of resources (e.g., resource 315-d, resource 315-e, resource 315-f, resource 315-g) to forward to one or more UEs. In such aspects, the NCR 305 may forward portions of the resources that are overlapping with the DTX/DRX configuration 310-b. For example, the NCR 305 may forward the resource 320-d, which is the portion of the resource 315-d that overlaps with the first active duration of the DTX/DRX configuration 310-b. The NCR 305 may also forward the resource 320-f, which is the portion of the resource 315-e that overlaps with the second active duration of the DTX/DRX configuration 310-b. The NCR 305 may refrain from forwarding portions of the resource 315-f and the resource 315-g since the resource 315-f and the resource 315-g fall outside of the active durations of the DTX/DRX configuration 310-b.

In some implementations, the network entity 105 may dynamically indicate resources for the NCR 305 to forward. For example, the network entity 105 may dynamically indicate a set of periodic or semi-persistent resources for the NCR 305 to forward, which may fall within the active durations of the DTX/DRX configuration 310-b, or outside of the active durations of the DTX/DRX configuration 310-b. In such examples, the NCR 305 may forward the dynamically granted resources, even if the dynamically granted resources fall outside of an active duration. For example, the NCR forwarding configuration 302 illustrates a dynamically granted resource 325, which is indicated by the network entity 105 for the NCR 305 to forward to one or more UEs. The NCR 305 forwards the full resource 320-e, which includes the dynamically granted resource 325.

The NCR forwarding configuration 303 illustrates communications between a network entity 105 and an NCR 305. The network entity 105 may transmit, to the NCR 305, an indication of a DTX/DRX configuration 310-c, which includes a set of active and inactive durations for the network entity 105. The network entity 105 may also transmit an indication of a set of resources (e.g., resource 315-h, resource 315-i, resource 315-j, resource 315-k) that are configured for forwarding by the NCR 305.

In some aspects, the NCR 305 may use the indication of the DTX/DRX configuration 310-c to determine which portions of the set of resources (e.g., resource 315-h, resource 315-i, resource 315-j, resource 315-k) to forward to one or more UEs. In such aspects, the NCR 305 may forward portions of the resources that are overlapping with the DTX/DRX configuration 310-c. For example, the NCR 305 may forward the resource 320-g, which is the portion of the resource 315-h that overlaps with the first active duration of the DTX/DRX configuration 310-c. The NCR 305 may also forward the resource 320-i, which is the portion of the resource 315-i that overlaps with the second active duration of the DTX/DRX configuration 310-c. The NCR 305 may refrain from forwarding portions of the resource 315-j and the resource 315-k since the resource 315-j and the resource 315-k fall outside of the active durations of the DTX/DRX configuration 310-c.

In some implementations, the network entity 105 transmit a flag 330 (e.g., an indication, one or more messages, a signal) that may indicate an expected forwarding behavior for the NCR 305. For example, the flag 330 may indicate a forwarding behavior that includes the NCR 305 forwarding one or more resources that fall outside of the active durations of the DTX/DRX configuration 310-c. In some aspects, the flag 330 may indicate that the resource 335 (which falls outside of the active durations of the DTX/DRX configuration 310-c) should be forwarded by the NCR 305. The NCR 305 may then forward the indicated resource as resource 320-h based on the flag. In some other examples, the flag 330 may indicate that the NCR 305 should continue to refrain from forwarding resources that fall outside of the active durations of the DTX/DRX configuration 310-c. In some implementations, the network entity 105 may dynamically indicate the flag 330 to the NCR 305 (e.g., via control signaling or other dynamic signaling), or the flag 330 may be configured or preconfigured for the NCR 305.

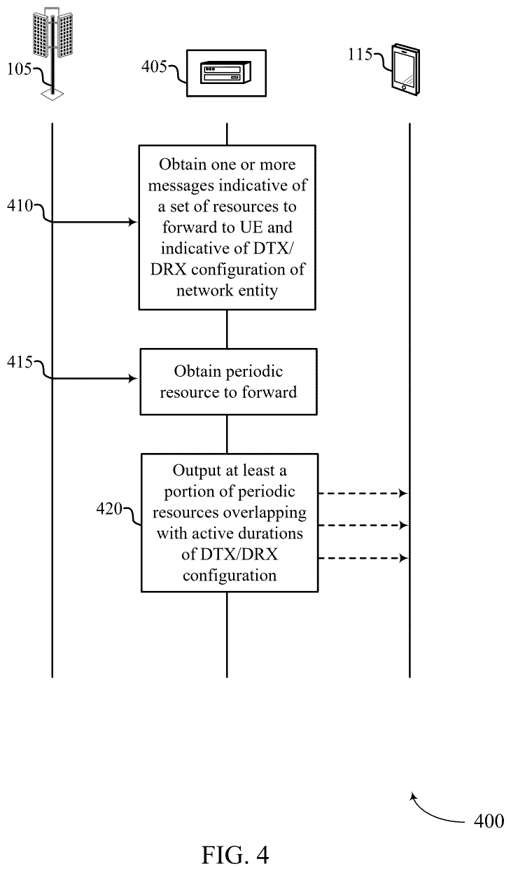

FIG. 4 shows an example of a process flow 400 that supports techniques to support NCR functionality for discontinuous communications in accordance with one or more aspects of the present disclosure.

The process flow 400 may implement or be implemented by aspects of wireless communications system 100, wireless communications system 200, or both. For example, the process flow 400 may include a UE 115, which may be an example of a UE 115 as described herein. The process flow 400 may also include a network entity 105, which may be an example of a network entity 105 (e.g., a gNB, an IAB node), and an NCR 405, each of which may be examples of network entities and NCRs as described herein. In the following description of the process flow 400, the communications and processes between the network entity 105, the NCR 405, and the UE 115 may be performed in a different order than the example order shown, or the communications and processes performed by the network entity 105, the NCR 405, and the UE 115 may be performed in different orders or at different times. Some operations may also be omitted from the process flow 400, and other operations may be added to the process flow 400. In some examples, the processes performed by the network entity 105, the NCR 405, and the UE 115 may be performed at different times or by additional or alternative devices.

At 410, the network entity 105 may output, and the NCR 405 may obtain, one or more messages indicative of a set of periodic resources to forward to one or more UEs (including at least the UE 115) and indicative of one or more inactive durations of a cell DTX cycle associated with a network entity 105, one or more inactive durations of a cell DRX cycle associated with the network entity 105, or both. In some examples, the one or more messages indicate the one or more inactive durations of the cell DTX cycle or the one or more inactive durations of the cell DRX cycle associated with both a serving cell and one or more non-serving cells of the NCR 405. In some examples, the one or more messages indicate an effective configuration for a combination of the one or more inactive durations of the cell DTX cycle or the one or more inactive durations of the cell DRX cycle associated with both a serving cell and one or more non-serving cells of the NCR 405. For example, the effective configuration may indicate overlapping active durations of the one or more inactive durations of the cell DTX cycle or the one or more inactive durations of the cell DRX cycle associated with both the serving cell and the one or more non-serving cells of the NCR 405. In some examples, the one or more messages may indicate a frequency allocation for a serving cell associated with the NCR 405 and respective frequency allocations for one or more non-serving cells of the NCR 405.

At 415, the NCR 405 may obtain, from the network entity 105, the set of periodic resources to forward to the one or more UEs including at least the UE 115.

At 420, the NCR 405 may output at least a portion of the set of periodic resources to the one or more UEs including at least the UE 115 in accordance with the one or more messages. In such cases, the portion of the set of periodic resources overlaps with one or more active durations of the cell DTX cycle, one or more active durations of the cell DRX cycle, or both.

In some examples, the NCR 405 may output a first portion of the set of periodic resources that are overlapping with the one or more active durations of the cell DTX cycle, the one or more active durations of the cell DRX cycle, or both. In such examples, at least the portion of the set of periodic resources omits one or more second portions of the set of periodic resources that are non-overlapping with the one or more active durations of the cell DTX cycle, the one or more active durations of the cell DRX cycle, or both.

In some other examples, the NCR 405 may output at least the portion of the set of periodic resources that are overlapping with the one or more active durations of the cell DTX cycle, the one or more active durations of the cell DRX cycle, or both. The NCR 405 may then obtain a set of dynamically granted resources (e.g., from the network entity 105) during one or more active or inactive durations of the cell DTX cycle, one or more active or inactive durations of the cell DRX cycle, or both. The NCR 405 may then output the set of dynamically granted resources during the one or more active or inactive durations of the cell DTX cycle, the one or more active or inactive durations of the cell DRX cycle, or both, based on the resources being dynamically granted by the network entity 105.

In some other examples, the NCR 405 may output a first portion of the set of periodic resources that are overlapping with the one or more active durations of the cell DTX cycle, the one or more active durations of the cell DRX cycle, or both. The NCR 405 may then obtain (e.g., from the network entity 105) a flag (e.g., a message, a field within a message, a signal) that indicates an expected forwarding behavior of the NCR 405. The NCR may then (based on the received flag) output one or more second portions of the set of periodic resources that are non-overlapping with the one or more active durations of the cell DTX cycle, the one or more active durations of the cell DRX cycle, or both. In some cases, the flag may be transmitted via dynamic signaling by the network entity 105. In some cases, the flag may be configured for the NCR 405. In some aspects, the flag may instruct the NCR 405 to output the one or more second portions of the set of periodic resources irrespective of whether the one or more second portions of the set of periodic resources are non-overlapping with the one or more active durations of the cell DTX cycle, the one or more active durations of the cell DRX cycle, or both.

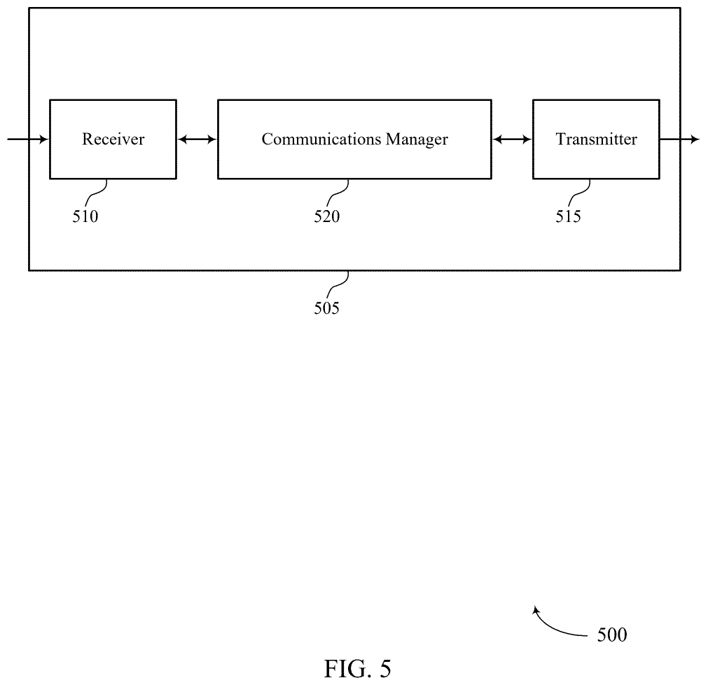

FIG. 5 shows a block diagram 500 of a device 505 that supports techniques to support NCR functionality for discontinuous communications in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations or components thereof may be examples of means for performing various aspects of techniques to support NCR functionality for discontinuous communications as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for obtaining one or more messages indicative of a set of periodic resources to forward to one or more user equipment (UEs) and indicative of one or more inactive durations of a cell DTX cycle associated with a network entity, one or more inactive durations of a cell DRX cycle associated with the network entity, or both. The communications manager 520 is capable of, configured to, or operable to support a means for obtaining, from the network entity, the set of periodic resources to forward to the one or more UEs. The communications manager 520 is capable of, configured to, or operable to support a means for outputting, from an NCR, at least a portion of the set of periodic resources to the one or more UEs in accordance with the one or more messages, where the portion of the set of periodic resources overlaps with one or more active durations of the cell DTX cycle, one or more active durations of the cell DRX cycle, or both.

Additionally, or alternatively, the communications manager 520 may support wireless communications in accordance with examples as disclosed herein. For example, the communications manager 520 is capable of, configured to, or operable to support a means for outputting one or more messages indicative of a set of periodic resources to forward from an NCR to one or more user equipment (UEs) and indicative of one or more inactive durations of a cell DTX cycle associated with the network entity, one or more inactive durations of a cell DRX cycle associated with the network entity, or both. The communications manager 520 is capable of, configured to, or operable to support a means for outputting, to the NCR, the set of periodic resources to forward to the one or more UEs based on the one or more messages.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, more efficient utilization of communication resources, more efficient implementation of DTX/DRX signaling, and more dynamic control for NCR devices.

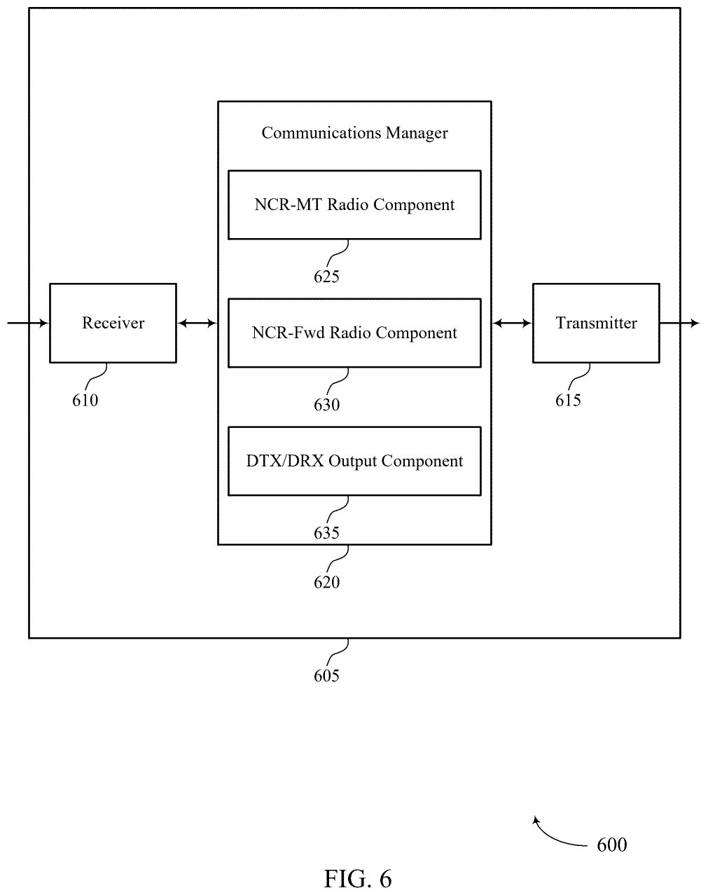

FIG. 6 shows a block diagram 600 of a device 605 that supports techniques to support NCR functionality for discontinuous communications in accordance with one or more aspects of the present disclosure. The device 605 may be an example of aspects of a device 505 or a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of techniques to support NCR functionality for discontinuous communications as described herein. For example, the communications manager 620 may include an NCR-MT radio component 625, an NCR-Fwd radio component 630, a DTX/DRX output component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The NCR-MT radio component 625 is capable of, configured to, or operable to support a means for obtaining one or more messages indicative of a set of periodic resources to forward to one or more user equipment (UEs) and indicative of one or more inactive durations of a cell DTX cycle associated with a network entity, one or more inactive durations of a cell DRX cycle associated with the network entity, or both. The NCR-MT radio component 625 is capable of, configured to, or operable to support a means for obtaining, from the network entity, the set of periodic resources to forward to the one or more UEs. The NCR-Fwd radio component 630 is capable of, configured to, or operable to support a means for outputting, from an NCR, at least a portion of the set of periodic resources to the one or more UEs in accordance with the one or more messages, where the portion of the set of periodic resources overlaps with one or more active durations of the cell DTX cycle, one or more active durations of the cell DRX cycle, or both.

Additionally, or alternatively, the communications manager 620 may support wireless communications in accordance with examples as disclosed herein. The DTX/DRX output component 635 is capable of, configured to, or operable to support a means for outputting one or more messages indicative of a set of periodic resources to forward from an NCR to one or more user equipment (UEs) and indicative of one or more inactive durations of a cell DTX cycle associated with the network entity, one or more inactive durations of a cell DRX cycle associated with the network entity, or both. The DTX/DRX output component 635 is capable of, configured to, or operable to support a means for outputting, to the NCR, the set of periodic resources to forward to the one or more UEs based on the one or more messages.

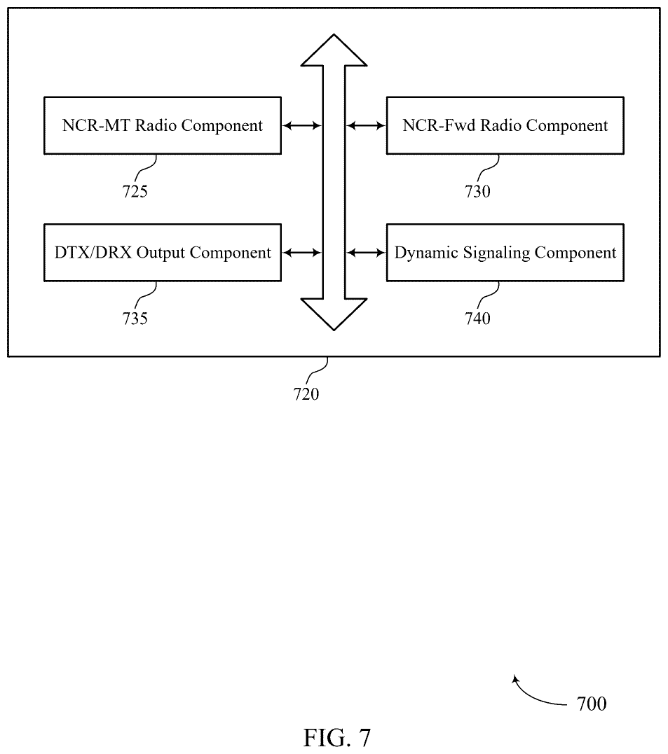

FIG. 7 shows a block diagram 700 of a communications manager 720 that supports techniques to support NCR functionality for discontinuous communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques to support NCR functionality for discontinuous communications as described herein. For example, the communications manager 720 may include an NCR-MT radio component 725, an NCR-Fwd radio component 730, a DTX/DRX output component 735, a dynamic signaling component 740, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The NCR-MT radio component 725 is capable of, configured to, or operable to support a means for obtaining one or more messages indicative of a set of periodic resources to forward to one or more user equipment (UEs) and indicative of one or more inactive durations of a cell DTX cycle associated with a network entity, one or more inactive durations of a cell DRX cycle associated with the network entity, or both. In some examples, the NCR-MT radio component 725 is capable of, configured to, or operable to support a means for obtaining, from the network entity, the set of periodic resources to forward to the one or more UEs. The NCR-Fwd radio component 730 is capable of, configured to, or operable to support a means for outputting, from an NCR, at least a portion of the set of periodic resources to the one or more UEs in accordance with the one or more messages, where the portion of the set of periodic resources overlaps with one or more active durations of the cell DTX cycle, one or more active durations of the cell DRX cycle, or both.

In some examples, the one or more messages indicate the one or more inactive durations of the cell DTX cycle or the one or more inactive durations of the cell DRX cycle associated with both a serving cell and one or more non-serving cells of the NCR.

In some examples, the one or more messages indicate an effective configuration for a combination of the one or more inactive durations of the cell DTX cycle or the one or more inactive durations of the cell DRX cycle associated with both a serving cell and one or more non-serving cells of the NCR.

In some examples, the effective configuration indicates overlapping active durations of the one or more inactive durations of the cell DTX cycle or the one or more inactive durations of the cell DRX cycle associated with both the serving cell and the one or more non-serving cells of the NCR.

In some examples, the one or more messages indicate a frequency allocation for a serving cell associated with the NCR and respective frequency allocations for one or more non-serving cells of the NCR.

In some examples, to support outputting at least the portion of the set of periodic resources to the one or more UEs, the NCR-Fwd radio component 730 is capable of, configured to, or operable to support a means for outputting a first portion of the set of periodic resources that are overlapping with the one or more active durations of the cell DTX cycle, the one or more active durations of the cell DRX cycle, or both, where at least the portion of the set of periodic resources omits one or more second portions of the set of periodic resources that are non-overlapping with the one or more active durations of the cell DTX cycle, the one or more active durations of the cell DRX cycle, or both.

In some examples, the set of periodic resources include periodic resources or semi-persistent resources and, to support outputting at least the portion of the set of periodic resources to the one or more UEs, the NCR-Fwd radio component 730 is capable of, configured to, or operable to support a means for outputting at least the portion of the set of periodic resources that are overlapping with the one or more active durations of the cell DTX cycle, the one or more active durations of the cell DRX cycle, or both. In some examples, the set of periodic resources include periodic resources or semi-persistent resources and, to support outputting at least the portion of the set of periodic resources to the one or more UEs, the NCR-MT radio component 725 is capable of, configured to, or operable to support a means for obtaining a set of dynamically granted resources during one or more active or inactive durations of the cell DTX cycle, one or more active or inactive durations of the cell DRX cycle, or both. In some examples, the set of periodic resources include periodic resources or semi-persistent resources and, to support outputting at least the portion of the set of periodic resources to the one or more UEs, the NCR-Fwd radio component 730 is capable of, configured to, or operable to support a means for outputting the set of dynamically granted resources during the one or more active or inactive durations of the cell DTX cycle, the one or more active or inactive durations of the cell DRX cycle, or both.

In some examples, the NCR-MT radio component 725 is capable of, configured to, or operable to support a means for outputting a first portion of the set of periodic resources that are overlapping with the one or more active durations of the cell DTX cycle, the one or more active durations of the cell DRX cycle, or both. In some examples, the NCR-MT radio component 725 is capable of, configured to, or operable to support a means for obtaining a flag that indicates an expected forwarding behavior of the NCR. In some examples, the NCR-Fwd radio component 730 is capable of, configured to, or operable to support a means for outputting, based on the flag, one or more second portions of the set of periodic resources that are non-overlapping with the one or more active durations of the cell DTX cycle, the one or more active durations of the cell DRX cycle, or both.

In some examples, to support obtaining the flag, the NCR-MT radio component 725 is capable of, configured to, or operable to support a means for receiving the flag via one or more dynamic messages from the network entity. In some examples, to support obtaining the flag, the NCR-MT radio component 725 is capable of, configured to, or operable to support a means for receiving the flag via the one or more messages indicative of the set of periodic resources to forward to one or more UEs, where the flag includes a configured indicator.

In some examples, the flag instructs the NCR to output the one or more second portions of the set of periodic resources irrespective of whether the one or more second portions of the set of periodic resources are non-overlapping with the one or more active durations of the cell DTX cycle, the one or more active durations of the cell DRX cycle, or both. In some examples, the network entity includes a gNB, an IAB node or other network node, or any combination thereof.

Additionally, or alternatively, the communications manager 720 may support wireless communications in accordance with examples as disclosed herein. The DTX/DRX output component 735 is capable of, configured to, or operable to support a means for outputting one or more messages indicative of a set of periodic resources to forward from an NCR to one or more user equipment (UEs) and indicative of one or more inactive durations of a cell DTX cycle associated with the network entity, one or more inactive durations of a cell DRX cycle associated with the network entity, or both. In some examples, the DTX/DRX output component 735 is capable of, configured to, or operable to support a means for outputting, to the NCR, the set of periodic resources to forward to the one or more UEs based on the one or more messages.

In some examples, the one or more messages indicate the one or more inactive durations of the cell DTX cycle or the one or more inactive durations of the cell DRX cycle associated with both a serving cell and one or more non-serving cells of the NCR.

In some examples, the one or more messages indicate an effective configuration for a combination of the one or more inactive durations of the cell DTX cycle or the one or more inactive durations of the cell DRX cycle associated with both a serving cell and one or more non-serving cells of the NCR.

In some examples, the effective configuration indicates overlapping active durations of the one or more inactive durations of the cell DTX cycle or the one or more inactive durations of the cell DRX cycle associated with both the serving cell and the one or more non-serving cells of the NCR.

In some examples, the one or more messages indicate a frequency allocation for a serving cell associated with the NCR, and respective frequency allocations for one or more non-serving cells of the NCR.

In some examples, the dynamic signaling component 740 is capable of, configured to, or operable to support a means for outputting a set of dynamically granted resources for the NCR to forward during one or more active or inactive durations of the cell DTX cycle, one or more active or inactive durations of the cell DRX cycle, or both.

In some examples, the dynamic signaling component 740 is capable of, configured to, or operable to support a means for outputting a flag that indicates an expected forwarding behavior of the NCR, where the flag instructs the NCR to output the set of periodic resources irrespective of whether the set of periodic resources are non-overlapping with one or more active durations of the cell DTX cycle, one or more active durations of the cell DRX cycle, or both.

In some examples, the network entity includes a gNB, an IAB node or other network node, or any combination thereof.

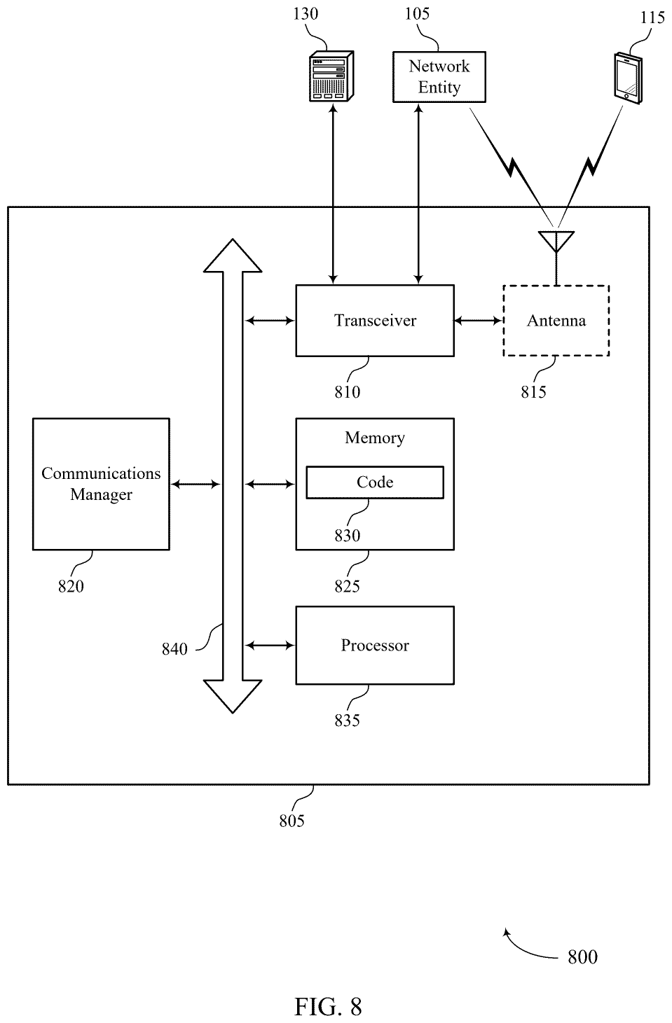

FIG. 8 shows a diagram of a system 800 including a device 805 that supports techniques to support NCR functionality for discontinuous communications in accordance with one or more aspects of the present disclosure. The device 805 may be an example of or include components of a device 505, a device 605, or a network entity 105 as described herein. The device 805 may communicate with other network devices or network equipment such as one or more of the network entities 105, UEs 115, or any combination thereof. The communications may include communications over one or more wired interfaces, over one or more wireless interfaces, or any combination thereof. The device 805 may include components that support outputting and obtaining communications, such as a communications manager 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting techniques to support NCR functionality for discontinuous communications). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825).

In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with one or more other network entities 105, and may include a controller or scheduler for controlling communications with UEs 115 (e.g., in cooperation with the one or more other network devices). In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for obtaining one or more messages indicative of a set of periodic resources to forward to one or more user equipment (UEs) and indicative of one or more inactive durations of a cell DTX cycle associated with a network entity, one or more inactive durations of a cell DRX cycle associated with the network entity, or both. The communications manager 820 is capable of, configured to, or operable to support a means for obtaining, from the network entity, the set of periodic resources to forward to the one or more UEs. The communications manager 820 is capable of, configured to, or operable to support a means for outputting, from an NCR, at least a portion of the set of periodic resources to the one or more UEs in accordance with the one or more messages, where the portion of the set of periodic resources overlaps with one or more active durations of the cell DTX cycle, one or more active durations of the cell DRX cycle, or both.

Additionally, or alternatively, the communications manager 820 may support wireless communications in accordance with examples as disclosed herein. For example, the communications manager 820 is capable of, configured to, or operable to support a means for outputting one or more messages indicative of a set of periodic resources to forward from an NCR to one or more user equipment (UEs) and indicative of one or more inactive durations of a cell DTX cycle associated with the network entity, one or more inactive durations of a cell DRX cycle associated with the network entity, or both. The communications manager 820 is capable of, configured to, or operable to support a means for outputting, to the NCR, the set of periodic resources to forward to the one or more UEs based on the one or more messages.

By including or configuring the communications manager 820 in accordance with examples as described herein, the device 805 may support techniques for improved communication reliability, extended network coverage, reduced network and device power consumption, more efficient utilization of communication resources, improved coordination between devices, longer battery life, more efficient implementation of DTX/DRX signaling, and more dynamic control for NCR devices.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of techniques to support NCR functionality for discontinuous communications as described herein, or the at least one processor 835 and the at least one memory 825 may be otherwise configured to, individually or collectively, perform or support such operations.

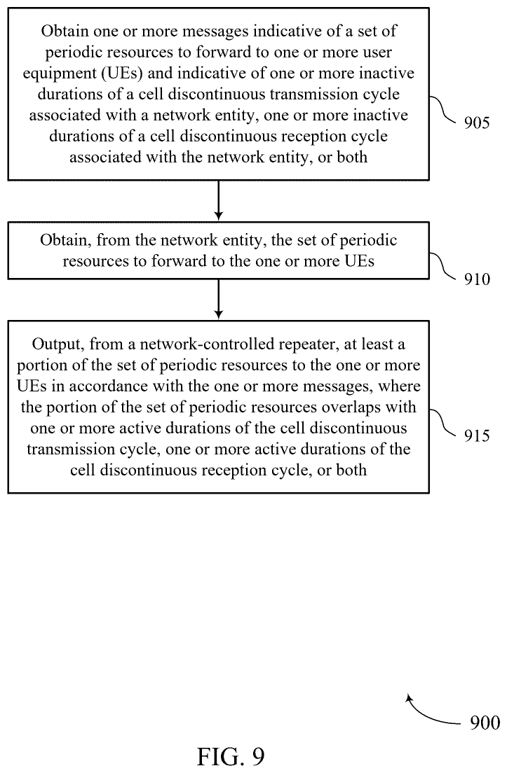

FIG. 9 shows a flowchart illustrating a method 900 that supports techniques to support NCR functionality for discontinuous communications in accordance with one or more aspects of the present disclosure. The operations of the method 900 may be implemented by a network entity or its components as described herein. For example, the operations of the method 900 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 905, the method may include obtaining one or more messages indicative of a set of periodic resources to forward to one or more user equipment (UEs) and indicative of one or more inactive durations of a cell DTX cycle associated with a network entity, one or more inactive durations of a cell DRX cycle associated with the network entity, or both. The operations of 905 may be performed in accordance with examples as disclosed herein. In some examples, aspects of the operations of 905 may be performed by an NCR-MT radio component 725 as described with reference to FIG. 7.

At 910, the method may include obtaining, from the network entity, the set of periodic resources to forward to the one or more UEs. The operations of 910 may be performed in accordance with examples as disclosed herein. In some examples, aspects of the operations of 910 may be performed by an NCR-MT radio component 725 as described with reference to FIG. 7.

At 915, the method may include outputting, from an NCR, at least a portion of the set of periodic resources to the one or more UEs in accordance with the one or more messages, where the portion of the set of periodic resources overlaps with one or more active durations of the cell DTX cycle, one or more active durations of the cell DRX cycle, or both. The operations of 915 may be performed in accordance with examples as disclosed herein. In some examples, aspects of the operations of 915 may be performed by an NCR-Fwd radio component 730 as described with reference to FIG. 7.

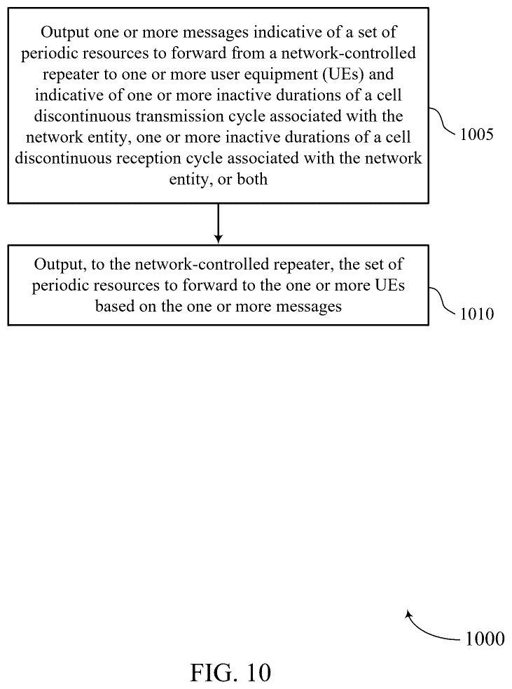

FIG. 10 shows a flowchart illustrating a method 1000 that supports techniques to support NCR functionality for discontinuous communications in accordance with one or more aspects of the present disclosure. The operations of the method 1000 may be implemented by a network entity or its components as described herein. For example, the operations of the method 1000 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1005, the method may include outputting one or more messages indicative of a set of periodic resources to forward from an NCR to one or more user equipment (UEs) and indicative of one or more inactive durations of a cell DTX cycle associated with the network entity, one or more inactive durations of a cell DRX cycle associated with the network entity, or both. The operations of 1005 may be performed in accordance with examples as disclosed herein. In some examples, aspects of the operations of 1005 may be performed by a DTX/DRX output component 735 as described with reference to FIG. 7.

At 1010, the method may include outputting, to the NCR, the set of periodic resources to forward to the one or more UEs based on the one or more messages. The operations of 1010 may be performed in accordance with examples as disclosed herein. In some examples, aspects of the operations of 1010 may be performed by a DTX/DRX output component 735 as described with reference to FIG. 7.

The following provides an overview of aspects of the present disclosure:

Aspect 1: A method for wireless communications, comprising: obtaining one or more messages indicative of a set of periodic resources to forward to one or more UEs and indicative of one or more inactive durations of a cell DTX cycle associated with a network entity, one or more inactive durations of a cell DRX cycle associated with the network entity, or both; obtaining, from the network entity, the set of periodic resources to forward to the one or more UEs; and outputting, from an NCR, at least a portion of the set of periodic resources to the one or more UEs in accordance with the one or more messages, wherein the portion of the set of periodic resources overlaps with one or more active durations of the cell DTX cycle, one or more active durations of the cell DRX cycle, or both.

Aspect 2: The method of aspect 1, wherein the one or more messages indicate the one or more inactive durations of the cell DTX cycle or the one or more inactive durations of the cell DRX cycle associated with both a serving cell and one or more non-serving cells of the NCR.

Aspect 3: The method of any of aspects 1 through 2, wherein the one or more messages indicate an effective configuration for a combination of the one or more inactive durations of the cell DTX cycle or the one or more inactive durations of the cell DRX cycle associated with both a serving cell and one or more non-serving cells of the NCR.

Aspect 4: The method of aspect 3, wherein the effective configuration indicates overlapping active durations of the one or more inactive durations of the cell DTX cycle or the one or more inactive durations of the cell DRX cycle associated with both the serving cell and the one or more non-serving cells of the NCR.

Aspect 5: The method of any of aspects 1 through 4, wherein the one or more messages indicate a frequency allocation for a serving cell associated with the NCR and respective frequency allocations for one or more non-serving cells of the NCR.

Aspect 6: The method of any of aspects 1 through 5, wherein outputting at least the portion of the set of periodic resources to the one or more UEs comprises: outputting a first portion of the set of periodic resources that are overlapping with the one or more active durations of the cell DTX cycle, the one or more active durations of the cell DRX cycle, or both, wherein at least the portion of the set of periodic resources omits one or more second portions of the set of periodic resources that are non- overlapping with the one or more active durations of the cell DTX cycle, the one or more active durations of the cell DRX cycle, or both.

Aspect 7: The method of any of aspects 1 through 6, wherein the set of periodic resources comprise periodic resources or semi-persistent resources, and outputting at least the portion of the set of periodic resources to the one or more UEs comprises: outputting at least the portion of the set of periodic resources that are overlapping with the one or more active durations of the cell DTX cycle, the one or more active durations of the cell DRX cycle, or both; obtaining a set of dynamically granted resources during one or more active or inactive durations of the cell DTX cycle, one or more active or inactive durations of the cell DRX cycle, or both; and outputting the set of dynamically granted resources during the one or more active or inactive durations of the cell DTX cycle, the one or more active or inactive durations of the cell DRX cycle, or both.

Aspect 8: The method of any of aspects 1 through 7, wherein outputting at least the portion of the set of periodic resources to the one or more UEs comprises outputting a first portion of the set of periodic resources, the method further comprising: outputting the first portion of the set of periodic resources that are overlapping with the one or more active durations of the cell DTX cycle, the one or more active durations of the cell DRX cycle, or both; obtaining a flag that indicates an expected forwarding behavior of the NCR; and outputting, based at least in part on the flag, one or more second portions of the set of periodic resources that are non-overlapping with the one or more active durations of the cell DTX cycle, the one or more active durations of the cell DRX cycle, or both.

Aspect 9: The method of aspect 8, wherein obtaining the flag comprises: receiving the flag via one or more dynamic messages from the network entity.

Aspect 10: The method of any of aspects 8 through 9, wherein obtaining the flag comprises: receiving the flag via the one or more messages indicative of the set of periodic resources to forward to one or more UEs, wherein the flag comprises a configured indicator.

Aspect 11: The method of any of aspects 8 through 10, wherein the flag instructs the NCR to output the one or more second portions of the set of periodic resources irrespective of whether the one or more second portions of the set of periodic resources are non-overlapping with the one or more active durations of the cell DTX cycle, the one or more active durations of the cell DRX cycle, or both.

Aspect 12: The method of any of aspects 1 through 11, wherein the network entity comprises a gNB, an IAB node or other network node, or any combination thereof.

Aspect 13: A method for wireless communications at a network entity, comprising: outputting one or more messages indicative of a set of periodic resources to forward from an NCR to one or more UEs and indicative of one or more inactive durations of a cell DTX cycle associated with the network entity, one or more inactive durations of a cell DRX cycle associated with the network entity, or both; and outputting, to the NCR, the set of periodic resources to forward to the one or more UEs based at least in part on the one or more messages.

Aspect 14: The method of aspect 13, wherein the one or more messages indicate the one or more inactive durations of the cell DTX cycle or the one or more inactive durations of the cell DRX cycle associated with both a serving cell and one or more non-serving cells of the NCR.

Aspect 15: The method of any of aspects 13 through 14, wherein the one or more messages indicate an effective configuration for a combination of the one or more inactive durations of the cell DTX cycle or the one or more inactive durations of the cell DRX cycle associated with both a serving cell and one or more non-serving cells of the NCR.

Aspect 16: The method of aspect 15, wherein the effective configuration indicates overlapping active durations of the one or more inactive durations of the cell DTX cycle or the one or more inactive durations of the cell DRX cycle associated with both the serving cell and the one or more non-serving cells of the NCR.

Aspect 17: The method of any of aspects 13 through 16, wherein the one or more messages indicate a frequency allocation for a serving cell associated with the NCR, and respective frequency allocations for one or more non-serving cells of the NCR.

Aspect 18: The method of any of aspects 13 through 17, further comprising: outputting a set of dynamically granted resources for the NCR to forward during one or more active or inactive durations of the cell DTX cycle, one or more active or inactive durations of the cell DRX cycle, or both.

Aspect 19: The method of any of aspects 13 through 18, further comprising: outputting a flag that indicates an expected forwarding behavior of the NCR, wherein the flag instructs the NCR to output the set of periodic resources irrespective of whether the set of periodic resources are non-overlapping with one or more active durations of the cell DTX cycle, one or more active durations of the cell DRX cycle, or both.

Aspect 20: The method of any of aspects 13 through 19, wherein the network entity comprises a gNB, an IAB node or other network node, or any combination thereof.

Aspect 21: An apparatus for wireless communications, comprising one or more memories storing processor-executable code, and one or more processors coupled with the one or more memories and individually or collectively operable to execute the code to cause the apparatus to perform a method of any of aspects 1 through 12.

Aspect 22: An apparatus for wireless communications, comprising at least one means for performing a method of any of aspects 1 through 12.

Aspect 23: A non-transitory computer-readable medium storing code for wireless communications, the code comprising instructions executable by one or more processors to perform a method of any of aspects 1 through 12.

Aspect 24: A network entity for wireless communications, comprising one or more memories storing processor-executable code, and one or more processors coupled with the one or more memories and individually or collectively operable to execute the code to cause the network entity to perform a method of any of aspects 13 through 20.

Aspect 25: A network entity for wireless communications, comprising at least one means for performing a method of any of aspects 13 through 20.

Aspect 26: A non-transitory computer-readable medium storing code for wireless communications, the code comprising instructions executable by one or more processors to perform a method of any of aspects 13 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
one or more memories storing processor-executable code; and
one or more processors coupled with the one or more memories and individually or collectively operable to execute the code to cause the apparatus to:
obtain one or more messages indicative of a set of periodic resources to forward to one or more user equipment (UEs) and indicative of one or more inactive durations of a cell discontinuous transmission cycle associated with a network entity, one or more inactive durations of a cell discontinuous reception cycle associated with the network entity, or both;
obtain, from the network entity, the set of periodic resources to forward to the one or more UEs; and
output, from a network-controlled repeater, at least a portion of the set of periodic resources to the one or more UEs in accordance with the one or more messages, wherein the portion of the set of periodic resources overlaps with one or more active durations of the cell discontinuous transmission cycle, one or more active durations of the cell discontinuous reception cycle, or both.

2. The apparatus of claim 1, wherein the one or more messages indicate the one or more inactive durations of the cell discontinuous transmission cycle or the one or more inactive durations of the cell discontinuous reception cycle associated with both a serving cell and one or more non-serving cells of the network-controlled repeater.

3. The apparatus of claim 1, wherein the one or more messages indicate an effective configuration for a combination of the one or more inactive durations of the cell discontinuous transmission cycle or the one or more inactive durations of the cell discontinuous reception cycle associated with both a serving cell and one or more non-serving cells of the network-controlled repeater.

4. The apparatus of claim 3, wherein the effective configuration indicates overlapping active durations of the one or more inactive durations of the cell discontinuous transmission cycle or the one or more inactive durations of the cell discontinuous reception cycle associated with both the serving cell and the one or more non-serving cells of the network-controlled repeater.

5. The apparatus of claim 1, wherein the one or more messages indicate a frequency allocation for a serving cell associated with the network-controlled repeater and respective frequency allocations for one or more non-serving cells of the network-controlled repeater.

6. The apparatus of claim 1, wherein, to output at least the portion of the set of periodic resources to the one or more UEs, the one or more processors are individually or collectively operable to execute the code to cause the apparatus to:
output a first portion of the set of periodic resources that are overlapping with the one or more active durations of the cell discontinuous transmission cycle, the one or more active durations of the cell discontinuous reception cycle, or both, wherein at least the portion of the set of periodic resources omits one or more second portions of the set of periodic resources that are non-overlapping with the one or more active durations of the cell discontinuous transmission cycle, the one or more active durations of the cell discontinuous reception cycle, or both.

7. The apparatus of claim 1, wherein the set of periodic resources comprise periodic resources or semi-persistent resources, and, to output at least the portion of the set of periodic resources to the one or more UEs, the one or more processors are individually or collectively operable to execute the code to cause the apparatus to:
output at least the portion of the set of periodic resources that are overlapping with the one or more active durations of the cell discontinuous transmission cycle, the one or more active durations of the cell discontinuous reception cycle, or both;
obtain a set of dynamically granted resources during one or more active or inactive durations of the cell discontinuous transmission cycle, one or more active or inactive durations of the cell discontinuous reception cycle, or both; and
output the set of dynamically granted resources during the one or more active or inactive durations of the cell discontinuous transmission cycle, the one or more active or inactive durations of the cell discontinuous reception cycle, or both.

8. The apparatus of claim 1, wherein, to output at least the portion of the set of periodic resources to the one or more UEs, the one or more processors are individually or collectively further operable to execute the code to cause the apparatus to:
output a first portion of the set of periodic resources that are overlapping with the one or more active durations of the cell discontinuous transmission cycle, the one or more active durations of the cell discontinuous reception cycle, or both;
obtain a flag that indicates an expected forwarding behavior of the network-controlled repeater; and
output, based at least in part on the flag, one or more second portions of the set of periodic resources that are non-overlapping with the one or more active durations of the cell discontinuous transmission cycle, the one or more active durations of the cell discontinuous reception cycle, or both.

9. The apparatus of claim 8, wherein, to obtain the flag, the one or more processors are individually or collectively operable to execute the code to cause the apparatus to:
receive the flag via one or more dynamic messages from the network entity.

10. The apparatus of claim 8, wherein, to obtain the flag, the one or more processors are individually or collectively operable to execute the code to cause the apparatus to:
receive the flag via the one or more messages indicative of the set of periodic resources to forward to one or more UEs, wherein the flag comprises a configured indicator.

11. The apparatus of claim 8, wherein the flag instructs the network-controlled repeater to output the one or more second portions of the set of periodic resources irrespective of whether the one or more second portions of the set of periodic resources are non-overlapping with the one or more active durations of the cell discontinuous transmission cycle, the one or more active durations of the cell discontinuous reception cycle, or both.

12. The apparatus of claim 1, wherein the network entity comprises a next generation node B (gNB), an integrated access and backhaul (IAB) node or other network node, or any combination thereof.

13. A network entity, comprising:
one or more memories storing processor-executable code; and
one or more processors coupled with the one or more memories and individually or collectively operable to execute the code to cause the network entity to:
output one or more messages indicative of a set of periodic resources to forward from a network-controlled repeater to one or more user equipment (UEs) and indicative of one or more inactive durations of a cell discontinuous transmission cycle associated with the network entity, one or more inactive durations of a cell discontinuous reception cycle associated with the network entity, or both; and
output, to the network-controlled repeater, the set of periodic resources to forward to the one or more UEs based at least in part on the one or more messages.

14. The network entity of claim 13, wherein the one or more messages indicate the one or more inactive durations of the cell discontinuous transmission cycle or the one or more inactive durations of the cell discontinuous reception cycle associated with both a serving cell and one or more non-serving cells of the network-controlled repeater.

15. The network entity of claim 13, wherein the one or more messages indicate an effective configuration for a combination of the one or more inactive durations of the cell discontinuous transmission cycle or the one or more inactive durations of the cell discontinuous reception cycle associated with both a serving cell and one or more non-serving cells of the network-controlled repeater.

16. The network entity of claim 15, wherein the effective configuration indicates overlapping active durations of the one or more inactive durations of the cell discontinuous transmission cycle or the one or more inactive durations of the cell discontinuous reception cycle associated with both the serving cell and the one or more non-serving cells of the network-controlled repeater.

17. The network entity of claim 13, wherein the one or more messages indicate a frequency allocation for a serving cell associated with the network-controlled repeater, and respective frequency allocations for one or more non-serving cells of the network-controlled repeater.

18. The network entity of claim 13, wherein the one or more processors are individually or collectively further operable to execute the code to cause the network entity to:
output a set of dynamically granted resources for the network-controlled repeater to forward during one or more active or inactive durations of the cell discontinuous transmission cycle, one or more active or inactive durations of the cell discontinuous reception cycle, or both.

19. The network entity of claim 13, wherein the one or more processors are individually or collectively further operable to execute the code to cause the network entity to:
output a flag that indicates an expected forwarding behavior of the network-controlled repeater, wherein the flag instructs the network-controlled repeater to output the set of periodic resources irrespective of whether the set of periodic resources are non-overlapping with one or more active durations of the cell discontinuous transmission cycle, one or more active durations of the cell discontinuous reception cycle, or both.

20. A method for wireless communications, comprising:
obtaining one or more messages indicative of a set of periodic resources to forward to one or more user equipment (UEs) and indicative of one or more inactive durations of a cell discontinuous transmission cycle associated with a network entity, one or more inactive durations of a cell discontinuous reception cycle associated with the network entity, or both;
obtaining, from the network entity, the set of periodic resources to forward to the one or more UEs; and
outputting, from a network-controlled repeater, at least a portion of the set of periodic resources to the one or more UEs in accordance with the one or more messages, wherein the portion of the set of periodic resources overlaps with one or more active durations of the cell discontinuous transmission cycle, one or more active durations of the cell discontinuous reception cycle, or both.
